(19) United States
(12) Patent Application Publication
(10) Pub. No.: US 2007/0226134 A1
(43) Pub. Date: Sep. 27, 2007

(54) Method and system for making taxable structured settlement payments

(75) Inventor: Roger W. Dinella, New York, NY (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: American International Group, Inc., New York, NY (US)

(21) Appl. No.: 11/385,276

(22) Filed: Mar. 21, 2006

(51) Int. Cl. G06Q 40/00

(52) U.S. Cl. 705/39

(57) ABSTRACT

A framework for providing structured settlement payment programs allows a claimant of a settlement for a non-physical tort injury to receive periodic future payments for the injury without triggering a current U.S. federal income tax liability on the present value of the future payments. The obligation of the defendant of the tort claim to make future periodic payments is assigned to an unlimited liability entity. The parent company that owns the entity is liable for the future payments if the unlimited liability entity fails to meet the obligation. However, the obligation assigned is an “unsecured promise to pay” and thus should not cause the claimant to be deemed in constructive receipt of the future payments. As a result, the claimant pays income tax on a periodic payment only when the payment has been actually received.

### FIELD OF THE INVENTION

The invention generally relates to structured payment programs for making periodic payments for settlements of tort claims, and more particularly to a framework for providing structured payment programs for settlement payments that are not excludable from the recipient's taxable income.

### BACKGROUND OF THE INVENTION

Historically, injury lawsuits were settled with a single lump sum payment. Lump sum settlements, especially in catastrophic bodily injury cases, often placed the injury victims and/or their families in a difficult financial position. Victims and their families have to adapt to a new lifestyle immediately as a consequence of the injury, and often do not have either the time or talent to manage the funds received. Often recipients or their guardians make poor investment choices or otherwise dissipate the funds in a financially unsound manner, resulting in significant financial hardship to the victims and ultimately reliance upon public assistance programs.

A structured payment program effectively addresses the issues associated with receiving a lump sum settlement payment. The compensation is structured as a stream of periodic payments tailored to meet the anticipated future medical expenses, basic living needs and other expected expenses of the injured person. A long-term structured settlement payment program is often a better option than a lump sum payment, because it provides guaranteed long-term income for the victim and his/her family, and gives them the ability to adapt or recuperate from the injury and associated losses without the need to actively manage the investment of the lump sum payment.

Under Internal Revenue Code (“IRC”) § 104, any recovery in settlement of a bodily physical injury is excluded from the taxpayer's income, and if payments are structured over time, any interest is also excluded from a taxpayer's income.

Structured settlement payments that qualify for tax exemption are often made through an “assignment company.” The defendant or its liability insurer may transfer the obligation to make future payments through a “qualified assignment” to the assignment company, which may be owned by a life insurance company. The assignment of the obligation relieves the defendant of future responsibility for the periodic payments, and once the obligation is transferred the defendant generally can close its book on the obligation. In addition to the payment obligation, the assignment company undertakes the administration and record-keeping responsibilities for the periodic payments. The assignment company may offset the assumed obligation's economic risk by purchasing an annuity from an affiliated carrier with the annuity's payment schedule matched to the assigned obligation. One significant advantage of this arrangement is that the annuity carrier's strong financial viability provides assurance to the assignment company that the payments can be timely made. In this structured settlement market, it is a common practice to issue to the recipient of the injury compensation a guarantee of the assignment company's obligation by a third party affiliate. Due to these advantages, structured programs for tax-free settlement payments have been widely used and have become a significant insurance market place, with 6 billion U.S. dollars of annuity premium written in 2005.

Structured payment programs have also been used for settlement payments that do not qualify for tax-free treatment under the existing U.S. income tax law. There are many types of non-physical tort injuries that are not eligible for the tax-free treatment accorded to compensation for physical injuries. Non-physical tort injuries may involve, for example, wrongful termination, age or gender discrimination, etc. The settlement payments for non-physical tort injuries are referred to as “non-qualified” because they do not qualify for tax-exempt status, and the recipient of the payments incurs U.S. federal income tax liability.

Like structured settlement payment programs for physical injuries, a structured payment for a non-physical tort injury has the benefit that it relieves the payment recipient of the need to manage a lump sum payment. Nevertheless, there have been uncertainties regarding whether the recipient of the periodic settlement payments incurs U.S. federal income tax liability upfront on the present value of the future payments. Existing “non-qualified” structured settlement payment programs are typically constructed such that the assignment company is a foreign entity. After the payment obligation is transferred to the offshore assignment company, the assignment company purchases an annuity program from a U.S. domestic life insurance company and arranges for the assignment company's obligation to be guaranteed by an affiliate of the annuity issuer. The guarantee may take the form of a guarantee from a parent of the life insurance company or the issuance of a surety bond by an affiliated property & casualty carrier. This practice, however, creates a potential issue regarding the taxation of the payments. For U.S. federal income tax purposes, receipt of taxable income may be actual or constructive (Treas. Reg. § 1.451-1(a)). Income is constructively received when it is credited to one's account, “set apart for him or otherwise available.” Treas. Reg. § 1.451-2(a). There is a question of whether the guarantee of the future payments could cause the claimant to be deemed in “constructive receipt” of the future payments, which would result in the claimant incurring a U.S. federal income tax liability upfront on the present value of the future payments. Such a tax consequence is highly undesirable to the settlement claimant.

### SUMMARY OF THE INVENTION

In view of the foregoing, it is an object of the invention to provide a framework for structured payments for settlements for non-physical tort injuries that offers the benefits of structured payments while ensuring that the recipient of the payments is not required to pay tax upfront on the present value of the future payments.

It is a related object of the invention to provide such a framework for structured settlement payments that provides substantial financial backing for the future periodic settlement payments without creating the potential adverse tax consequences associated with a guarantee for the future payments.

These objects and other related objects are achieved by the present invention, which provides a framework to offer structured payment programs for settlements that are not tax-exempt under IRC § 104. Such a settlement may be for a tort claim of a non-physical injury, and may be referred to as “non-qualified,” meaning that the underlying injury is not eligible for tax-exempt treatment under IRC § 104. In accordance with a feature of the invention, a legal entity with unlimited liability—e.g., (1) a Delaware statutory trust (a “Trust”) with formation documents providing for its liability to flow to its beneficial owner or (2) a partnership—is used as an assignment company (the “Assignee”) for obligations assigned to make periodic payments resulting from a settlement for a non-physical tort injury. In one embodiment described below, the Assignee will be a Trust. As discussed above, however, the Assignee could be another entity with unlimited liability—such a partnership formed under state law—and this application is intended to cover such other unlimited liability entities.) The Trust is owned by a parent company, which preferably has substantial net worth and financial viability. The settlement agreement between the defendant and the victim of the non-physical injury tort claim generally provides that the obligation to make periodic payments for compensating the victim can be assigned to the Trust. Pursuant to the assignment agreement, the Trust will be responsible for making the periodic payments. In this context, the victim receiving the payments is referred to as the “claimant.” After assuming the obligation for the structured settlement payments, the Trust generally would offset the obligation's economic risk by purchasing an annuity from an affiliated life insurance company. Because of the Trust's unlimited liability, the parent company will be held liable if the Trust fails to meet its obligation to make the periodic payments. There is, however, no explicit guarantee from any related company to make such payments. The obligation of the Trust for the structured future payments is an “unsecured promise,” which does not cause the claimant to be deemed in “constructive receipt” of the settlement payments. As a result, the claimant should not incur U.S. federal income tax liability until the claimant's actual receipt of those payments.

The advantages of the invention can be understood from the description of embodiments of the invention set forth below with reference to the drawings, in which:

### BRIEF DESCRIPTION OF THE DRAWING(S)

FIG. 1 is a schematic diagram showing a victim asserting a non-physical tort claim and a defendant accused of the tort reaching a settlement agreement that has provisions for compensating the victim by means of future periodic payments;

FIG. 2 is a schematic diagram showing a framework in accordance with an embodiment of the invention for providing structured settlement payment programs for non-physical injury tort claims; and

FIG. 3 is a flowchart showing a method of providing structured future payments under a settlement for a non-physical injury tort claim using the framework of FIG. 2.

### DETAILED DESCRIPTION OF THE INVENTION

The present invention is directed to a novel business framework for enabling a non-physical injury tort victim to receive periodic future payments from the defendant of the tort claim(s) under a settlement agreement without undesired income tax consequences.

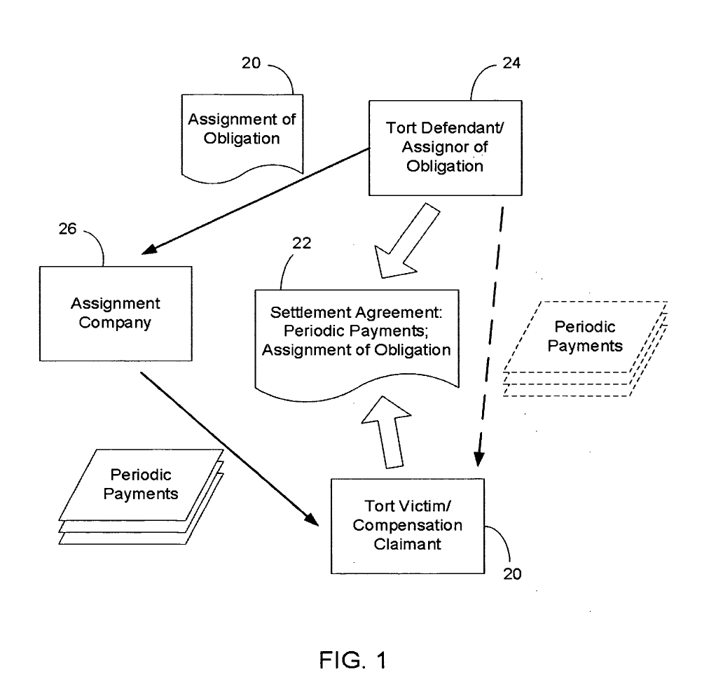

As shown in FIG. 1, to settle a tort claim of a non-physical tort injury, the person 20 claiming to be the tort victim enters an a settlement agreement 22 with the defendant 24 of that tort claim. The settlement agreement 22 specifies that part or all of the monetary compensation will be paid to the tort victim 20 in the form of periodic payments to be made in the future. In this context, the victim 20 is the claimant for the future periodic payments. Because the tort is not of a physical injury type as defined in IRC § 104, it is not qualified for tax exemption for U.S. federal income tax purposes. As a result, if the payments are made directly from the defendant 24 to the claimant 20, the cash-basis taxpayer/claimant will incur income tax liability only upon receipt of the payments. In other words, the tax on a future payment is deferred until the claimant has actually received that payment.

The tax consideration may be different, however, if the defendant transfers or assigns the obligation to make future payments to another entity, referred to as the assignment company 26, and the assignment company 26 obtains from another company a guarantee that the future payments will be made to the claimant 20. There is a concern that the existence of the guarantee might cause the claimant to be deemed in “constructive receipt” of the future payments, thereby triggering current tax liability for the claimant on the present value of the future payments. In contrast, this issue does not exist for structured settlement payments to a victim of a physical injury, because such payments are explicitly excluded by IRC § 104 from the taxable income of the recipient.

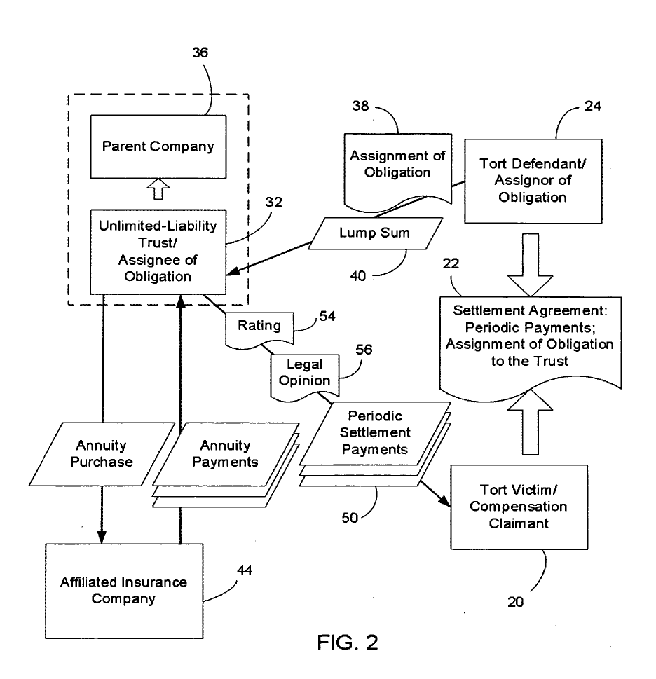

In accordance with a feature of the invention, a framework is provided to allow the parties of a settlement for a tort claim involving a non-physical injury to use a structured payment program offered by a business entity without the concern that the claimant will immediately incur U.S. federal income tax liability. In accordance with an embodiment of the invention, as illustrated in FIG. 2, the Trust 32, with unlimited liability to its beneficial owner, is set up as the assignee of the obligation to make periodic payments to the claimant 20. Such a Trust may be set up, for example, under the laws of the State of Delaware (DEL. CODE ANN. tit. 12, § 3903(a)). In this regard, it will be appreciated that even though the framework of this invention was originally designed in view of the U.S. federal income tax requirements, it is possible that it can be employed in other countries where guaranteed future periodic payments might be deemed constructively received for tax purposes, and where the applicable law allows the formation of an entity of unlimited liability (not necessarily a trust) as an assignee of the obligation for future payments.

An advantage of using an unlimited liability entity, the Trust 32, as the assignee of the obligation to make future periodic payments is that there is no need for the entity to obtain a guarantee of the payments to provide comfort to the claimant that the Trust has the financial backing to make the future payments. Preferably, the Trust 32 is formed and wholly owned by a parent company 36 that has substantial net worth and long-term financial viability. One example of such a company is American General Corporation, a Texas corporation, which is a wholly-owned direct subsidiary of and principal life insurance holding company for American International Group, Inc., the world's leading international insurance and financial services organization that operates in approximately 130 countries and jurisdictions. Due to the unlimited-liability status of the Trust 32, the parent company 36 owning the Trust 32 will be liable for all debts and other liabilities of the Trust 32 to the extent that they are not satisfied directly by the Trust 32. In this way, the Trust 32 provides strong financial backing for the obligation to make future payments to the claimant 20. It is important to note, however, that the liability on the part of the parent company 36 arises not because of a separate guarantee, but rather as a result of the formation of the Trust 32 as an unlimited liability entity.

To utilize the Trust 32, the settlement agreement 22 between the defendant 24 and the victim/claimant 20 provides that (1) part or all of the compensation to the victim will be structured as future periodic payments, and (2) part or all of the obligation to make the periodic payments may be assigned to the Trust 32. By means of an assignment 38 from the defendant 24, the Trust 32 assumes the obligation for future payments to the claimant 20 in return for a lump-sum payment 40 by the defendant. In this context, the defendant 24 is the assignor of the obligation, and the Trust 32 is assignee. The claimant 20 consents in the settlement agreement 22, in advance of the assignment, to the transfer of the obligation to the Trust 32, and agrees to release the defendant/assignor 24 from liability for the periodic settlement payments upon execution of the assignment 38.

Under the terms of the settlement agreement 22, the obligation assumed by the Trust 32 is an unsecured promise to make future payments to the claimant 20. The obligation is not structured or regulated as an annuity or as insurance. Although the settlement agreement 22 will not mandate the purchase of a structured annuity, it is the assignee's proposed plan to offset the obligation through the purchase of a structured annuity from a highly rated affiliated life insurance company 44. The settlement agreement 22 provides that the obligation assigned to the Trust 32 is no greater than that previously owed by the defendant/assignor 24. Also, the Trust 32 is not required to set aside specific assets to secure the assumed obligation. The claimant 20 will have rights against the Trust 32 as a general creditor. The settlement agreement 22 further provides that the claimant's rights to payments would be non-assignable and non-transferable, with all attempted assignments and transfers void. The claimant 20 will covenant not to pledge its rights to the future payments 50 to secure any obligation or debt of the claimant or for any other purposes.

Absent the assignment 38 of the obligation to the Trust 32, if the periodic payments are made directly by the assignor 24 to the claimant 20, the claimant would recognize income only when the payments are received. As a cash-basis taxpayer, the claimant 20 will be taxable only in the year in which he/she receives the payments as income. The assignment 38 of the obligation for future periodic settlement payments to the Trust 32 does not change the tax liability of the claimant 20.

Specifically, the assignment of the obligation does not render the future payments 50 to be “constructively received” by the claimant 20. For U.S. federal tax income purposes, income is constructively received when it is credited to one's account, “set apart for him or otherwise made available.” Treas. Reg § 1.451-2(a). A number of cases and IRS rulings have dealt with the question of whether a right to receive future payments is considered a current constructive receipt of the fair market value of the future payments. The rule that has emerged is that “a deferred-payment obligation which is readily marketable and immediately convertible to cash” is currently taxable at its fair market value,” but the “receipt of a mere unsecured promise to pay is not taxable income upon receipt.” Therefore, to the extent that the assignor's obligation under the settlement agreement 22 is a mere unsecured promise to make future payments to the claimant 20, the assignor's obligation per se would not cause the claimant 20 to be deemed in constructive receipt. The assignment of the obligation to the trust 32 should not change the tax treatment of the claimant 20, and the claimant should continue to be taxed only when he/she actually receives payments from the trust. The rationale for not considering the claimant 20 in constructive receipt of the present value of future payments 50 from the trust 32 is that the trust's obligation is merely a non-transferable unsecured promise to make future payments. The unsecured nature of the periodic payments 50 should not cause the claimant 20 to be considered to have received anything currently.

To provide assurance to the claimant 20 that the trust is in good financial condition to meet the obligation for the future payments, the trust may be rated by a highly regarded independent rating agency. The rating 54 of the trust 32 will be communicated to the claimant. Also, to educate the claimant 20 (and the claimant's tax and legal advisors) regarding certain U.S. federal income tax liabilities associated with the future payments, a discussion of certain U.S. federal income tax issues—in the form of a legal analysis 56—will be made available to the claimant (although the claimant may not rely on the legal analysis). This analysis may be initially provided by a recognized law firm, and ultimately may be substituted with a Private Letter Ruling (PLR) issued by the Internal Revenue Service, or if the framework of the invention is used in another country, via a tax analysis of the corresponding jurisdiction.

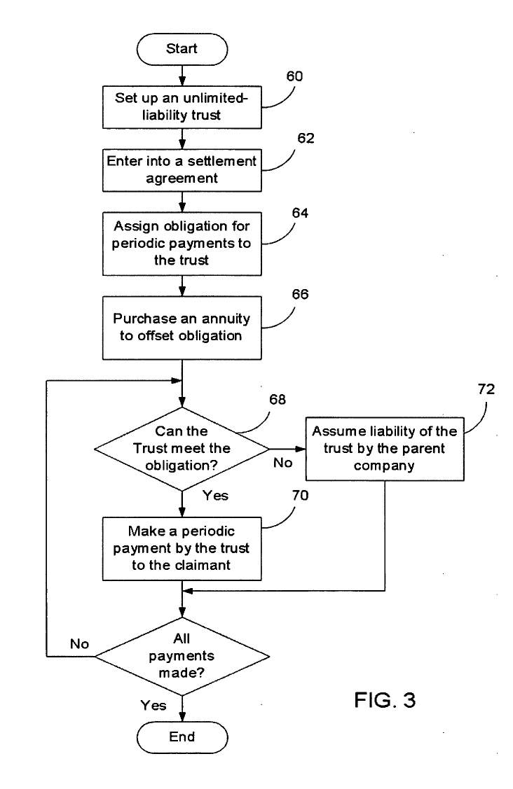

The method of an embodiment of the invention for providing structured payments for settlement of a non-physical-injury tort claim is summarized in FIG. 3. The structured payment program is made available by setting up an unlimited liability entity, the Trust 32 (step 60). The parties (the victim/claimant 20 and the defendant 22) to the tort claim enter into a settlement agreement (step 62), which specifies that the obligation to make future periodic payments may be assigned by the defendant (assignor) 24 to the unlimited-liability entity, the Trust 32. The obligation is assigned to the Trust 32 in accordance with an assignment agreement, with a lump-sum paid by the defendant 24 to the Trust 32 (step 64). After the assignment 38 of the obligation, the Trust 32 may offset the liability by purchasing an annuity from a reliable annuity provider, using the lump-sum received from the defendant to pay for the annuity (step 66). There is, however, no separate guarantee provided or obtained for the obligation to make the future payments. Thereafter, the Trust 32 makes periodic settlement payments 50 to the claimant 20 (step 70). If for some reason the Trust 32 is not able to meet the obligation to make the unsecured promised payments (step 68), the parent company 36 that owns the Trust 32 will be held liable for the payments (step 72), as a result of the unlimited-liability status of the trust.

The Trust may accept the assignment of numerous obligations from multiple claimants and defendants, and each claimant will have rights against the Trust only as a general creditor.

In view of the many possible embodiments to which the principles of this invention may be applied, it should be recognized that the embodiment described herein with respect to the drawing Figures is meant to be illustrative only and should not be taken as limiting the scope of invention. Those of skill in the art will recognize that the elements of the illustrated embodiments can be modified in arrangement and detail without departing from the spirit of the invention. Therefore, the invention as described herein contemplates all such embodiments as may come within the scope of the following claims and equivalents thereof.

1. A method of making periodic payments to a claimant under a settlement agreement with a defendant, comprising:
providing an unlimited liability entity;
assuming by the unlimited liability entity from the defendant an obligation to make future periodic payments to the claimant according to the settlement agreement between the claimant and the defendant; and
making, by the unlimited liability entity, periodic payments to the claimant in accordance with the assumed obligation.

2. A method as in claim 1, wherein the settlement agreement is for a tort claim of a non-physical tort injury.

3. A method as in claim 1, wherein the future periodic payments are not excluded from the taxable income of the claimant.

4. A method as in claim 1, including the step of providing a rating of the unlimited liability entity to the claimant.

5. A method as in claim 3, including the step of making available a legal analysis indicating that the claimant should not be required to pay U.S. federal income tax on the present value of the future periodic payments.

6. A method as in claim 1, wherein the step of assuming includes receiving an assignment of the obligation from the defendant.

7. A method as in claim 1, wherein the step of assuming further includes providing in the settlement agreement that the obligation may be assigned to the unlimited liability entity.

8. A method as in claim 1, further including the step of satisfying the obligation by a parent company that owns part or all of the unlimited liability entity when such entity is not able to meet the obligation.

9. A method as in claim 1, wherein the step of assuming the obligation includes receiving a lump sum payment from the defendant.

10. A system for providing structured settlement payment programs, comprising:
a parent company; and
an unlimited liability wholly or partially owned by the parent company and being set up for assuming an obligation from a defendant of a non-physical-injury tort claim to make future periodic payments to a claimant under a settlement agreement between the claimant and the defendant.
